(19) United States
(12) Patent Application Publication
(10) Pub. No.: US 2006/0255900 A1
(43) Pub. Date: Nov. 16, 2006

(54) Transformers

(76) Inventor: Kazuo Kohno, Sanbu-gun (JP)

Correspondence Address: WENDEROTH, LIND & PONACK, L.L.P., 2033 K STREET N. W., SUITE 800, WASHINGTON, DC, 20006-1021, US

(21) Appl. No.: 11/407,241

(22) Filed: Apr. 20, 2006

(30) Foreign Application Priority Data
May 16, 2005 (JP) JP2005-142921
Jun. 22, 2005 (JP) JP2005-182184

(51) Int. Cl. H01F 27/24

(52) U.S. Cl. 336/212

(57) ABSTRACT

An object of the present invention is to provide a miniaturized and winding type output transformer suitable for multiple outputs with an excellent efficiency, wherein the I type cores are respectively inserted and disposed in more than two pieces of cylindrical bobbins which are arranged in parallel at a predetermined interval and being mutually coupled, and C type cores are disposed by being piled up in a perpendicular direction relative to the parallel plane at a predetermined interval on the parallel plane of the I type cores, and a magnetic closed circuit is formed by combining the convex portions at both ends of the C type cores to both end portions of the two pieces of the I typecores. Primary windings are mounted on each of the I type cores by means of the bobbins, and secondary windings are mounted in the adjacency of both sides of the primary windings.

### TECHNICAL FIELD

The present invention relates to transformers for use in inverters or the like that drive a luminaire like cold cathode type fluorescent lamp (CCFL) or external electrode fluorescent lamp (EEFL) or EL plate (electroluminescence plate) and the like,

### BACKGROUND TECHNOLOGIES

Heretofore, as shown in the official gazette of JAPAN PATENT KOKAI KOHO H 10-70031 or FIG. 19, transformers of multi-outputs formed by mounting a primary winding 4 and a plurality of secondary windings 8 on a square ring type core 2 are known to the art.

Furthermore, as shown in JAPAN PATENT KOKAI 2005-39050 or FIG. 20, transformers of a type formed by coupling an E type core 10 and E type core 12 and mounting a primary winding 14 on a core portion in the middle, and mounting secondary windings 16, 18 on the core portions of its both sides are known in the art.

In the conventional transformers of a type wherein the square ring type core or E-E type cores are used, and because of coupling of parallel portions 2b, 10a of the core mounted with windings in plane direction by means of right angle portions 2a, 12b, the entire unit becomes a large size in width direction, namely, in horizontal and plane direction relative to the substrate, and an occupied area of the transformer on the substrate in its plane direction becomes a large size which are the problems.

An object of the present invention is to provide a transformer of multi-output type suitable for its miniaturization. Furtheremore, another object of the present invention is to provide a transformer of one input multi-output type suitable for driving a plurality of the luminaire with an electric circuit that constitutes a single closed loop.

### SUMMARY OF INVENTION

The present invention is constructed in such a way that at least two pieces of I type cores disposed at predetermined interval in parallel and C type cores disposed on the parallel plane of the I type cores at predetermined interval by being superimposed relative to the parallel plane and convex portions of both ends are coupled with both end portions of the I type cores are provided, and the primary windings are mounted on the I type cores by means of the bobbins respectively and the secondary windings are mounted at both sides of the primary windings. By this construction, the secondary side of the transformer is at least made as the 4 winding outputs. Furthermore, the secondary winding can be constructed with a plurality of electric wires which are arranged in parallel. In this case, the secondary side of the transformer may be made as at least 8 windings outputs.

Furthermore, the present invention is constructed in that a terminal mounting portion is provided in a high-voltage terminal disposing region of the bobbin, and the first terminal connected to one terminal of the secondary winding is mounted at the terminal mounting portion in the high-voltage terminal disposing region, and the second terminal connected to the other terminal of the secondary winding mounted on the bobbin is mounted in the low-voltage terminal disposing region in the rear part at a predetermined distance relative to the high-voltage terminal disposing region, and the second terminal is made as the ground terminal.

Still furthermore, the primary winding is mounted in the center of the each bobbin, and both the sides of the primary winding are mounted on the secondary winding, and the terminal mounting portion in the low-voltage disposing region is provided at both the sides of the primary winding.

Furthermore, the present invention is constructed in that the winding direction of the portion of the primary winding adjacent to the secondary winding is made identical with the winding direction of the secondary winding.

Furthermore, the present invention is constructed in that a winding end terminal side of the secondary winding closer to the primary winding is connected to the ground terminal, and as a result, high potential difference seldom occurs in the border of the primary winding and the secondary winding.

Furthermore, the present invention is constructed in that each terminal mounting portion is provided at the rear of each of the secondary windings, and a secondary ground terminal is provided at the terminal mounting portion, and a winding end of the secondary winding is connected to the secondary ground terminal.

Furthermore, this invention is constructed in that the high-voltage secondary terminal of the terminal mounting portion provided at one side of the I type core is connected to a connector having a pair of terminals for lamp connection and the high-voltage secondary terminal of the terminal mounting portion of the other side of the I type core is connected to another connector having a pair of terminals for lamp connection.

The present invention is constructed as set forth in the foregoing, whereby the primary winding and the secondary winding are tightly connected to provide a transformer of high efficiency suitable for a plurality of outputs and miniaturization. Furthermore, the present invention is capable of providing a transformer suitable for driving a large number of luminaire on an electronic circuit consisting of a single closed loop.

### BRIEF DESCRIPTION OF DRAWINGS

FIG. 1 is a bottom view of the transformer according to the present invention.

FIG. 2 is a side view of the transformer.

FIG. 3 is an exterior view of the core.

FIG. 4 is the explanatory view of the present invention.

FIG. 5 is a bottom view showing another embodiment of the present invention.

FIG. 6 is a bottom view showing another embodiment of the present invention.

FIG. 7 is a bottom view showing another embodiment of the present invention.

FIG. 8 is a bottom view showing another embodiment of the present invention.

FIG. 9 is a circuit explanatory view of the present invention.

FIG. 10 is a circuit explanatory view of the present invention.

FIG. 11 is a bottom view showing another embodiment of the present invention.

FIG. 12 is a bottom view showing another embodiment of the present invention.

FIG. 13 is an explanatory view of the present invention.

FIG. 14 is an exterior explanatory view of another embodiment of the present invention.

FIG. 15 is an exterior explanatory view of another embodiment of the present invention.

FIG. 16 is an exterior explanatory view of another embodiment of the present invention.

FIG. 17 is a bottom exterior explanatory view of another embodiment of the present invention.

FIG. 18 is a bottom exterior explanatory view of another embodiment of the present invention.

FIG. 19 is an explanatory view of the conventional technique.

FIG. 20 is an explanatory view of the conventional technique.

### DETAILED DESCRIPTION OF THE INVENTION

The construction of the present invention will be described in detail in the following by referring to the attached drawings.

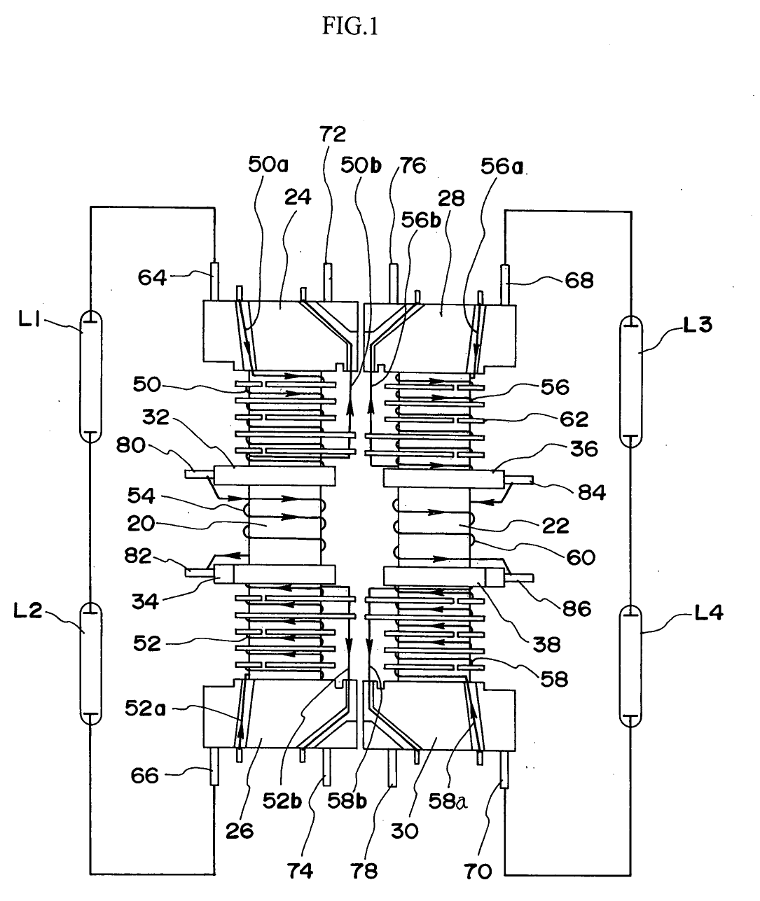

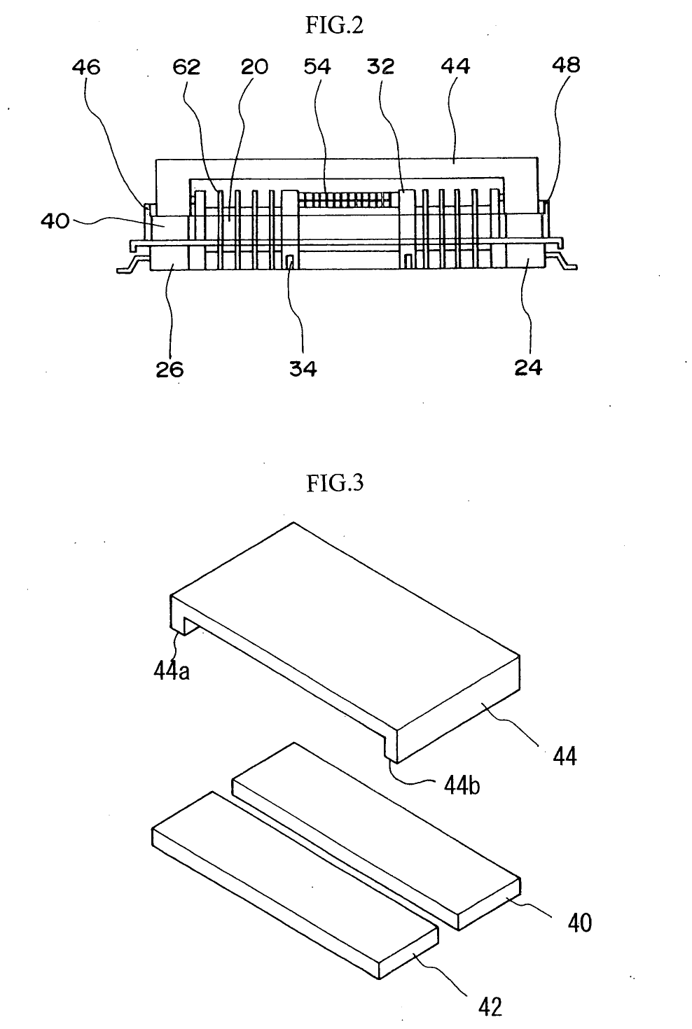

FIG. 1 is the bottom view of the transformer. In the drawing, numerals 20, 22 are cylindrical bobbins which are arranged in parallel and in a raw, and terminal mounting portions 24, 26, and 28, 30 are integrally formed at each end in the longitudinal direction. The I type cores 40, 42 are inserted in the bobbins 20, 22 as shown in FIG. 3. Numeral 44 is a C type core consisting of a flat plate portion and a convex portion projecting in a right angle direction at both ends of its longitudinal direction, and is disposed in opposition in perpendicular direction relative to the arranged plane of two pieces of the I type cores 40, 42.

One end convex surface 44a of the C type core 44 abuts and is fixed to one of two pieces of T type cores by means of a cutout portion 46 formed on the terminal mounting portions 30, 26 and also, abuts across the each core to be connected. The other end convex surface 44b of the C type core 44 abuts and is fixed to each of two pieces of the T type cores 40, 42 by means of the notched portions 48 formed on the terminal mounting portions 28, 24 and abuts and is fixed to 2 pieces of the I type cores 40, 42 by crossing each other portions.

Secondary winding 50 is wound between the terminal mounting portions 24 and 32 of the bobbin 20, and the secondary winding 52 is wound between the terminal mounting portions 34 and 26, and the primary winding 54 is wound between the terminal mounting portions 32 and 34. Furthermore, the secondary winding 56 is wound between the terminal mounting portions 28 and 36 of the bobbin 22, and the secondary winding 58 is wound between the terminal mounting portions 38 and 30, and the primary winding 60 is wound between the terminal mounting portions 36 and 38. In the drawings, the arrow marks attached to each of the windings indicate the winding directions based on the winding start end of the winding.

Between the terminal mounting portions 24 and 32 of each of the bobbins 20 and 22, and also between the terminal mounting portions 28 and 36 and also between the terminal mounting portions 38 and 30, a plurality of sheets of partitions 62 for insulation are respectively provided. The winding start ends 50a, 52a, 56a, 58a of the secondary windings 50, 52, 56, 58 are connected to the secondary side terminals 64, 66, 68, 70 by means of the grooves of the terminal mounting portions, and the winding terminate ends are connected to the secondary side terminals 72, 74, 76, 78 by means of the lead wires 50b, 52b, 56b, 58b.

Both terminals of the primary winding 54 are connected to the primary side terminals 80, 82, and both terminals of the primary winding 60 are connected to the primary side terminals 84, 86. The primary side terminals 86, 80 are connected in series by means of the lead wires, whereby the primary side terminals 84, 82 constitute an input terminal. For reference, primary side terminals 84, 80 are connected by means of the lead wires, and the primary side terminals 82, 86 are connected by means of the lead wires, whereby the primary windings 54, 60 may be connected in parallel.

In the foregoing construction, the transformer is mounted on the printed circuit board, and the primary side input terminals 82, 84 of the transformer are connected to the output side of the AC signals of the inverter circuit.

Lamps L1, L2 such as cold cathode type fluorescent lamps that are serially connected are connected between the terminals 64, 66 at the primary side by means of the connector (no illustration) and the lamps L3, L4 such as cold cathode type fluorescent lamps are connected between the terminals 68, 70 at the primary side by means of the connectors, The end portion of the side loser to the primary windings 54, 60 of the secondary windings 50, 52, 56, 58 are earthed through the secondary side terminals 72, 74 and 76, 78. The secondary side terminals 72, 74 and 76, 78 constitute the ground terminals and the ground terminals are earthed by means of a high-resistant element.

When the AC signals are inputted to the primary windings 54, 60, magnetic circuits are formed in the two pieces of the I type cores 40, 42, and the high-voltage AC output voltage is generated in the secondary windings 50, 52, 56 and 58. The direction of the magnetic flux formed in the I type cores 40, 42 are identical. The winding direction of the secondary windings 50, 52 are set in counter direction as shown in the drawing with the arrow direction, and the terminals 64, 66 are mutually of counter phases.

Similarly, the high-voltage secondary side terminals 68, 70 are mutually of counter phase. Accordingly, when the terminals 64, 68 are plus charge, the terminals 66, 70 become minus charge.

FIG. 5 shows another embodiment of the present invention, and the secondary windings 50, 56 are wound so as to be of mutually counter direction, and the secondary side terminals 64, 68 are mutually in counter phase. Furthermore, the secondary windings 52, 58 are wound so as to be of mutually counter direction, and the secondary side terminals 66, 70 are of mutually counter phase. Accordingly, when the terminals 68, 66 are plus charge, the terminals 64, 70 become the minus charge. The lamps L1, L2 which are connected in series are connected between the secondary side terminals 64, 68 by means of the connectors, and the lamps L3, L4 which are mutually connected in series are connected between the secondary terminals 66, 70 by means of the connectors. Other constructions are identical with the embodiments as shown in FIG. 1, and its description is omitted.

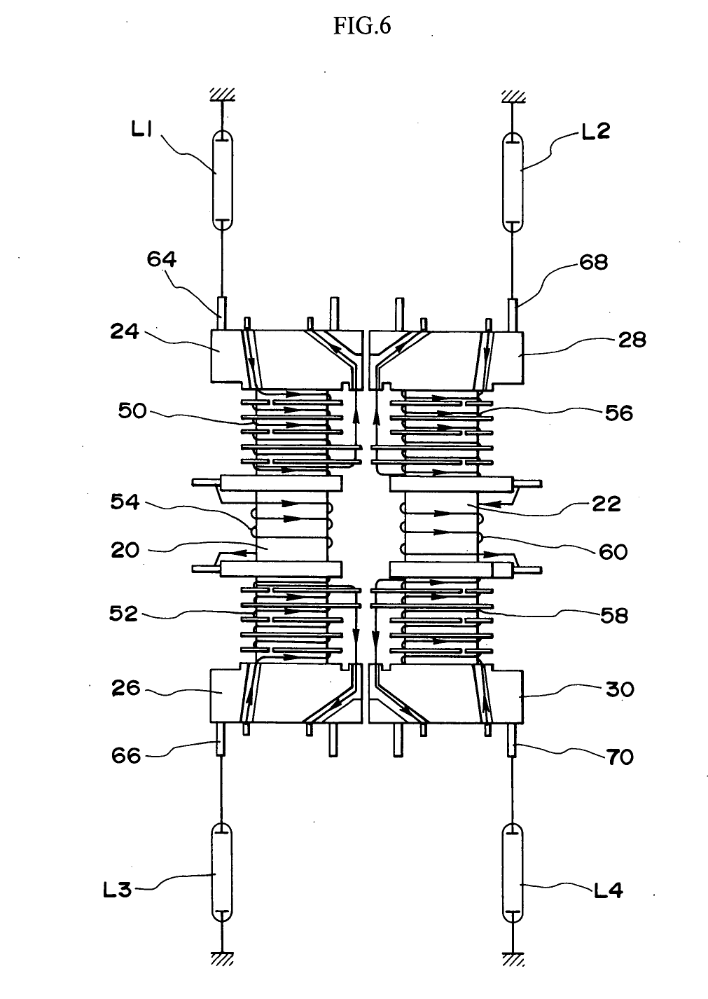

FIG. 6 shows another embodiment of the present invention, wherein the secondary windings 50, 52 are wound in mutually same direction on the bobbin 20, and the secondary windings 56, 58 are wound in mutually same direction on the other bobbin 22. Accordingly, when the terminals 64, 68 are the plus charge, the terminals 66, 70 are the plus charge. One side electrodes of the lamps L1, L2, L3, L4 are connected as shown in the drawing to the the secondary side terminals 64, 68. 66, 70 by means of the connectors, and the other electrodes of the lamps L1, L2, L3, L4 are earthed. Other constructions are identical with the embodiment shown in FIG. 1, and its description is omitted.

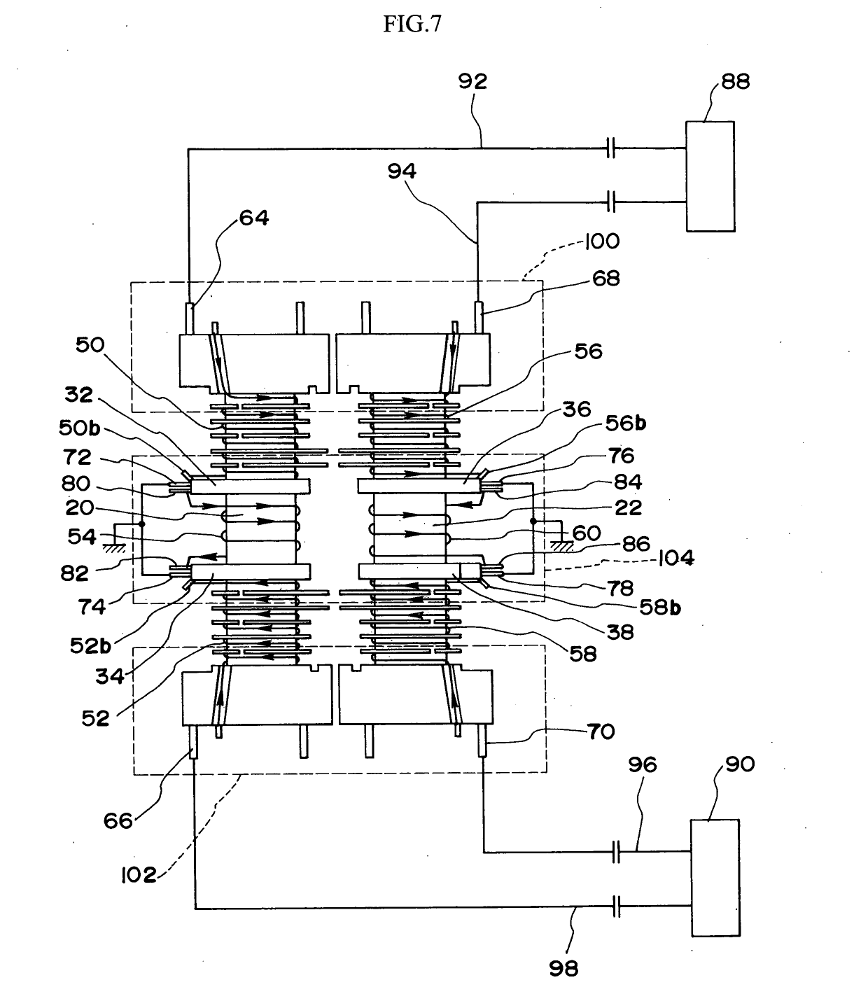

FIG. 7 shows another embodiment of the present invention, and the secondary side terminals 72, 74 are provided on the terminal mounting portions 32, 34 mounted at both end sides of the primary winding 54 in the axial direction which is mounted on the bobbin 20, and the secondary side terminals 76, 78 are provided at the terminal mounting portions 36, 38 provided at both end sides of the primary winding 60 in the axial direction which is mounted on the bobbin 22. The winding terminate ends 50b. 52b of the secondary windings 50, 52 are connected to the secondary side terminals 72, 74 corresponding to the respective windings, and the winding terminate ends 56b, 58b of the secondary windings 56, 58 are connected to the secondary side terminals 76, 78 respectively corresponding thereto.

The secondary side terminals 72, 74, 76, 78 are earthed by means of the lead wires, whereby the secondary side ground terminals are formed. Numerals 88, 90 denote connectors mounted on the printed circuit board (illustration is omitted), and the lamp (illustration is omitted) mounted on the circuit board (illustration is omitted) is connected to the connector as shown in FIG. 1. The connector 88 is connected to the secondary side terminals 64, 68 by means of the lead wires 92, 94, and the connector 90 is connected to the secondary side terminals 66, 70 by means of the lead wires 98, 96. Other constructions are identical with the embodiment shown in FIG. 1, and its description is omitted.

In the foregoing construction, the transformer is divided into a high voltage terminal disposed regions 100, 102 opposed to the connectors 88, 90 in a shortest distance, and low voltage terminal disposed regions 104 positioned in the rear of the high voltage terminal disposed regions 100, 102 relative to the connectors 88, 90. With this arrangement, there is not a chance for the low voltage secondary side terminals 72, 74, 76, 78 entering into the high-voltage regions 100, 102, and the insulation distance between the secondary side terminals 64 and 72, and between the secondary side terminals 68 and 76, and between the secondary side terminals 66 and 74 and between the secondary side terminals 70 and 78, and thus, the discharge and the like can be prevented between them, and thus, the transformer can be safely operated.

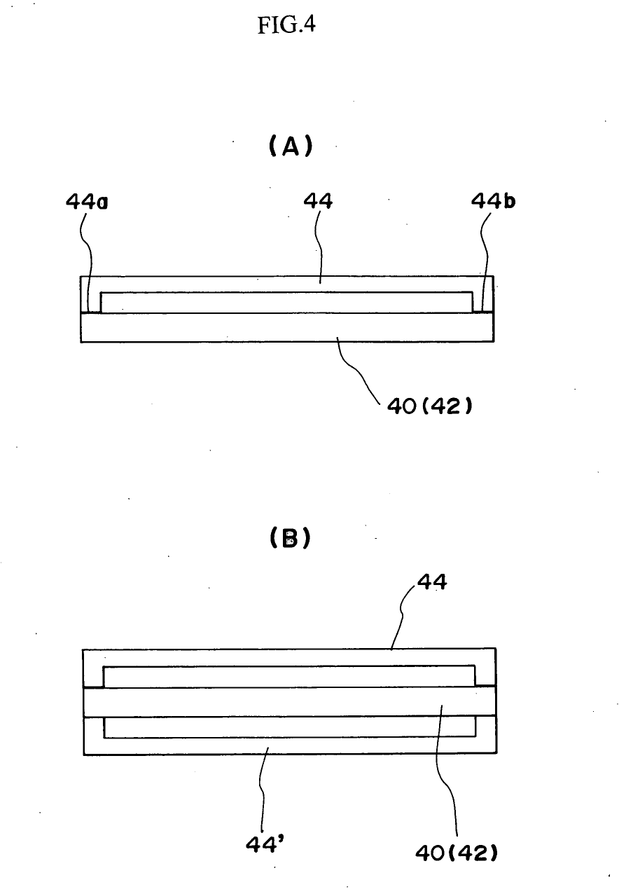

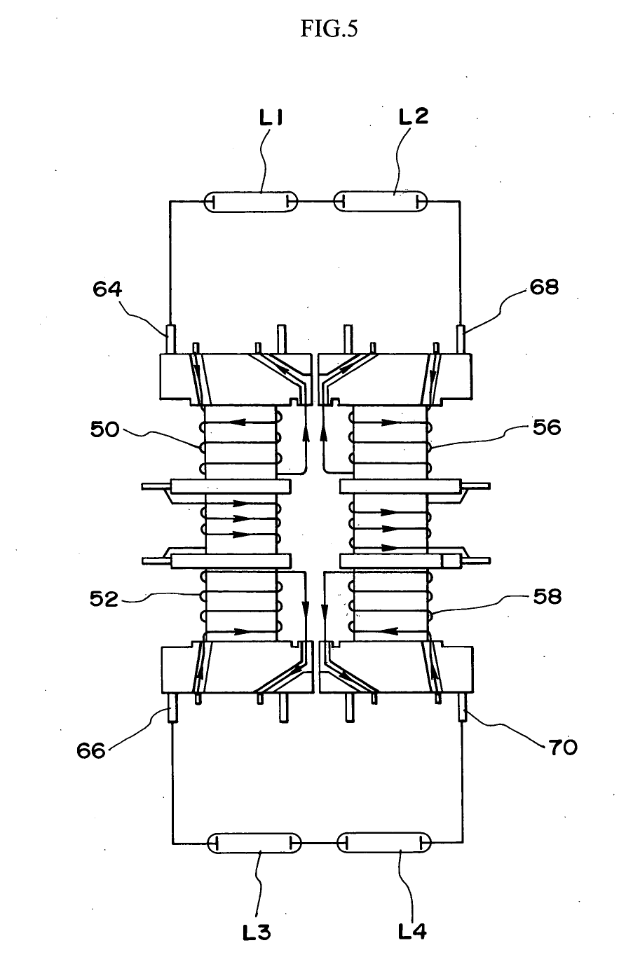

For reference, a coupling structure of the I type core and the C type core may be formed as shown in FIG. 4B to form a closed magnetic circuit by disposing two pieces of the C type cores 44, 44′ at upper and lower and both surface sides of the I type cores 40, 42, and by bonding the convex portions of both ends of the C type cores 44, 44′ to the I type core 40. In the construction of FIG. 4B, the space formed by the windings mounted on the I type cores 40, 42 by means of the bobbin and the printed circuit board on which the transformer is mounted is magnetically sealed by the C type core 44′, and thus, the electric insulation effect can be made effective. Furthermore, the C type core may be formed of a single C type core by combining the L type core and the I type core. And yet, the secondary windings 50, 52, 56, 58 may be formed of so called bifiler winding, namely, winding two pieces or a plurality of coil electric wires in parallel, which enables to obtain multiple outputs.

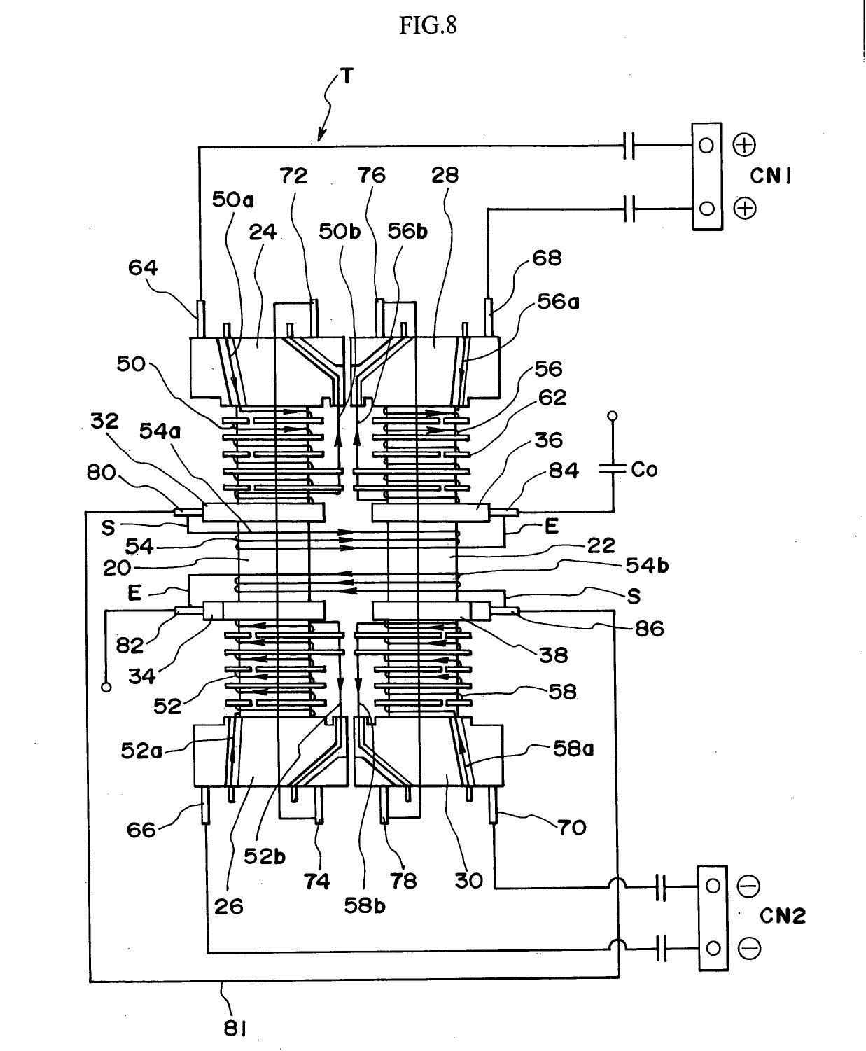

Another embodiment of the present invention will be described in the following by referring to FIG. 8.

FIG. 8 shows a bottom view of the transformer. The primary winding 54 is wound between the terminal mounting portions 32 and 34, and between the terminal mounting portions 36 and 38 across two pieces of the bobbins 20, 22. The primary winding 54 is divided into two pieces of parts 54a, 54b which are in mutually counter direction mode. Among two pieces of the part 54a, 54b of the primary winding 54, the winding start end (S) of the part 54a adjacent to the secondary windings 50, 56 is connected to the primary side terminal 80 of the terminal mounting portion 32, and the winding terminate end (E) is connected to the primary side terminal 84 of the terminal mounting portion 36. Among the parts 54a, 54b, the winding start end (S) of the part 54b adjacent to the secondary windings 52, 58 is connected to the primary side terminal 86 of the terminal mounting portion 38. and the winding terminate end (E) is connected to the primary side terminal 82 of the terminal mounting portion 34.

The part 54a of the primary winding 54 is wound in right-turn direction as shown with the arrow mark based on the winding start end (S) in FIG. 8, and the part 54b is wound in the left-turn direction based on the winding start end (S). The secondary winding 50 is connected to the high-voltage secondary side terminal 64 wherein its winding start end 50a is disposed at the end portion of the outside of the terminal mounting portion 24. The winding terminate end 50b of the secondary winding 50 is returned to the terminal mounting portion 24 along the periphery of the secondary winding 50, and is connected to the secondary side ground terminal 72 disposed inside of the terminal mounting portion 24. The secondary winding 52 is connected to the high-voltage secondary side terminal 66 wherein its winding start end 52a is disposed at the end portion of the outside of the terminal mounting portion 26, and its winding terminate end 52b is returned to the terminal mounting portion 26 along the periphery of the secondary winding 52, and is connected to the secondary ground terminal 74 disposed at the inside of the terminal mounting portion 26.

The secondary winding 56 is connected to the high-voltage secondary side terminal 68 disposed at the end portion of the outside of the terminal mounting portion 28, and the winding terminate end 56b is returned to the terminal mounting portion 28 along the periphery of the secondary winding 56, and is connected to the secondary ground terminal 76 disposed at the inside of the terminal mounting portion 28. The secondary winding 58 is connected to the high-voltage secondary side terminal 70 wherein the winding start end 58a is disposed at the end portion of the outside of the terminal mounting portion 30, and the winding terminate end 58b is returned to the terminal mounting portion 30 along the periphery of the secondary winding 58, and is connected to the secondary ground terminal 78 disposed at the inside of the terminal mounting portion 30. The primary side terminal 80 and the primary side terminal 86 are connected in series by means of the lead wire 81. The primary side terminals 84 and 82 constitute the primary input portion.

The secondary windings 50, 56 on the bobbins 20, 22 are wound in the right-turn direction with the winding start ends 50a, 56a respectively as the base in FIG. 8, and are mutually in identical phase. The secondary windings 52, 58 are wound in the left-turn direction with the winding start ends 52a, 58a as the standard and are in mutually identical phase. As described in the foregoing, the secondary windings 50, 56 are the right-turn, and the secondary windings 52, 58 are the left-turn, and they are mutually in counter phase relationship. By this winding direction, in case the secondary side terminals 64, 68 are the plus charge, the secondary side terminals 66, 70 become the minus charge.

The portion 54a adjacent to the secondary windings 50, 56 of the primary winding 54 becomes the right-turn direction identical with the secondary windings 50, 56 with the winding start end as the base, and the portion 54b adjacent to the secondary windings 52, 58 becomes the left-turn direction identical with the secondary windings 52, 58. As explained in the foregoing, when the winding directions of the winding adjacent to the primary winding and the secondary winding are arranged to be identical, the colliding of the magnetism, namely, the interference of the line of the magnetic force can be eliminated. Other constructions of the present embodiment are identical with the constructions of the embodiment shown in FIG. 1, and identical codes are applied to the corresponding portions.

In the foregoing construction, the transformer T is mounted on the printed circuit board, and the side of the AC signal output of the inverter circuit is connected to the primary side terminals 84, 82 of the transformer T, and this AC signal is inputted between the primary side-terminals 84, 82.

On the printed circuit board, the connectors CN1, CN2 for lamp connection are fixed and disposed in correspondence to the transformer T. Among a pair of the terminals A and B of the connector CN1, the high-voltage secondary side terminal 64 is connected to the one terminal A by means of the ballast capacitor, and the high-voltage secondary side terminal 68 is connected to the other terminal B by means of the ballast capacitor.

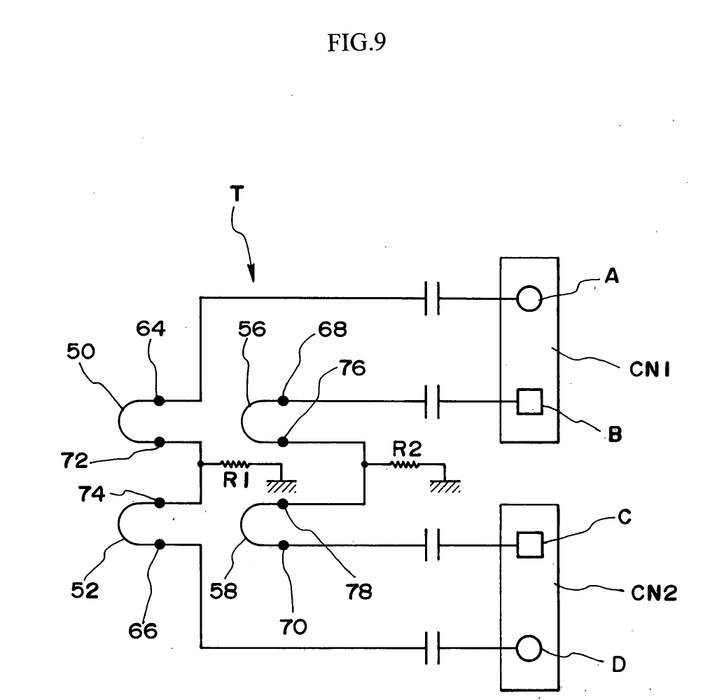

Furthermore, among a pair of the terminals of the connector CN2, the high-voltage secondary side terminal 70 is connected to the one terminal C by means of the ballast capacitor, and the high-voltage secondary side terminal 66 is connected to the other terminal D by means of the ballast capacitor. The secondary side ground terminals 72, 74 are connected in series by means of the lead wires, and similarly, the secondary side ground terminals 76, 78 are connected in series by means of the lead wire, and these lead wires are respectively earthed by means of the high resistance element such as the resistors R1, R2 (refer to FIG. 9) of 1 mega (Q).

FIG. 9 shows the relationship of the secondary windings 50, 52, 56, 58 of the transformer T with 1 input 4 winding output and the connectors CN1, CN2. The terminals A and B of the connector CN1 are mutually in identical phase, and the terminals C, D of the connector CN2 are mutually in identical phase relationship. Namely, when the terminals A and B are the plus charge, the terminals C, D become the minus charge. The secondary windings 50, 52 and the secondary windings 56, 58 are connected in series by means of the lead wires.

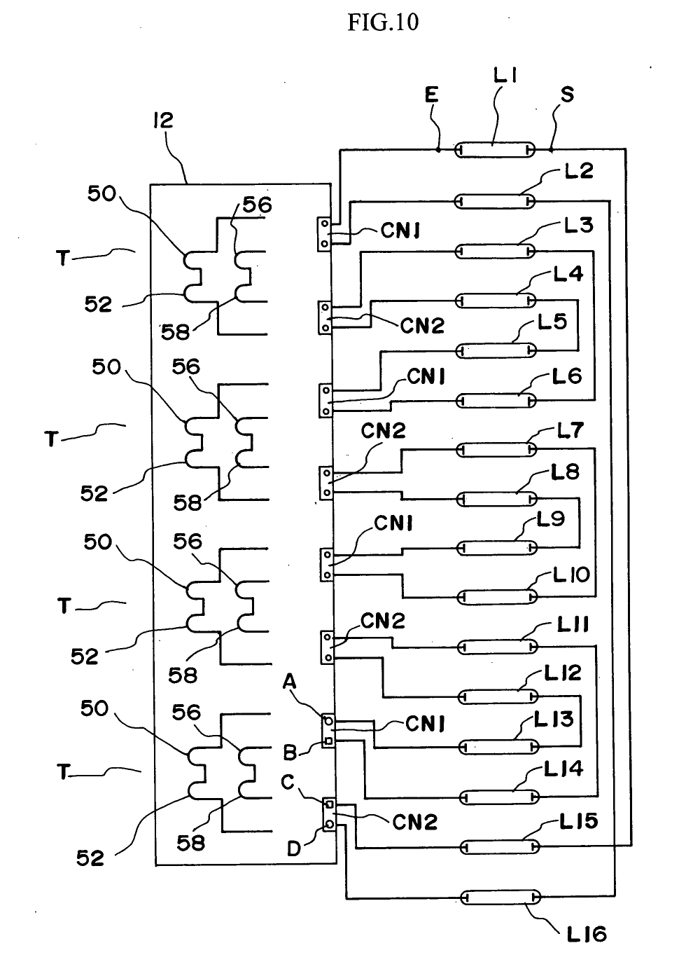

In the foregoing construction, on the printed circuit board, one or a plurality of 1 input 4 winding output transformer are disposed, and as a result, it becomes possible to drive the lamps arranged relative to the terminals of the connectors corresponding to each of the transformers efficiently with an electronic circuit consisting of one piece of closed loop. With respect to the embodiment mode for driving 16 lamps such as the cold cathode type fluorescent lamps and the like, the description is provided in the following by referring to FIG. 10.

4 pieces of the transformers T are arranged in a row on the printed circuit board 12, and a pair of the connectors CN1, CN2 is arranged in a row corresponding to each of the transformers T. A pair of the connectors CN1, CN2 corresponding to each of the transformers T are connected as shown in FIG. 10. Furthermore, on the lamp support board (illustration is omitted), 2 pieces of the lamps for one connector are disposed in a row so that the lamps become in parallel. Electrodes of the lamps L1-L16 in a total of 16 pieces are connected to the terminals of the corresponding connectors by means of the lead wires.

In FIG. 10, the other electrode of the lamp L1 that is number one from the top is connected to the other electrode of the lamp L15 that is the second from the bottom, and the other electrode of the lamp L2 that is the number 2 from the top is connected to the other electrode of the lamp L16 that is the number 1 from the bottom. Each of the other electrodes of the lamps L3-L14 which are in the middle are connected to the other electrodes of the lamps connected to the terminals of the counter phase in the order from the top in FIG. 10.

The electronic circuit of the lamps L1-L16 which are connected in the foregoing manner constitutes one closed loop, for example, assuming the electrode S of the lamp L1 as the starting point, the electrode S, lamp L15, connector CN2, windings 58, 56 of the transformer T, connector CN1, lamp L14, lamp L11, connector CN2, windings 58, 56 of the transformer T, connector CN1, lamp L10, lamp L7, connector CN2, windings 58, 56 of the transformer T, connector CN1, lamp L6, Lamp L3, connector CN2, windings 58, 56 of the transformer T, connector CN1, lamp L2, lamp L16, connector CN2, windings 52, 50 of the transformer T, connector CN1, lamp L13, lamp L12, connector CN2, windings 52, 50 of the transformer T, connector CN1, lamp L9, lamp L8, connector CN2, windings 52, 50 of the transformer T, connector CN1, lamp L5, lamp L4, connector CN2, windings 52, 50 of the transformer T, connector CN1 and the electrode E of the lamp L1 to return to the starting point S.

As shown in the foregoing, it becomes possible to light up the whole lamps with a uniform brightness by forming the electronic circuit of the lamps in one piece of the closed loop.

In the connection construction of the lamps, the voltage of the counter phase of the transformer T is applied to each of both terminals of a pair of the lamps L1, L15, L2, L16, L3, L6, L4, L5, L7, L10, L8, L9 which are connected in series, and each pair of the lamps is lighted up with the high voltage.

Furthermore, in FIG. 8, the primary winding 54 is not limited to a construction of its winding across the bobbins 20, 22, and it may be wound on the bobbins 20, 22. In this case, the portion of the primary winding 54 may be formed of 5 pieces. Also, the present invention is not limited to the construction of 2 pieces of the I type core, and 3, 4 pieces or a plurality of pieces of the I type core are arranged in parallel, and those cores may be connected with the C type core.

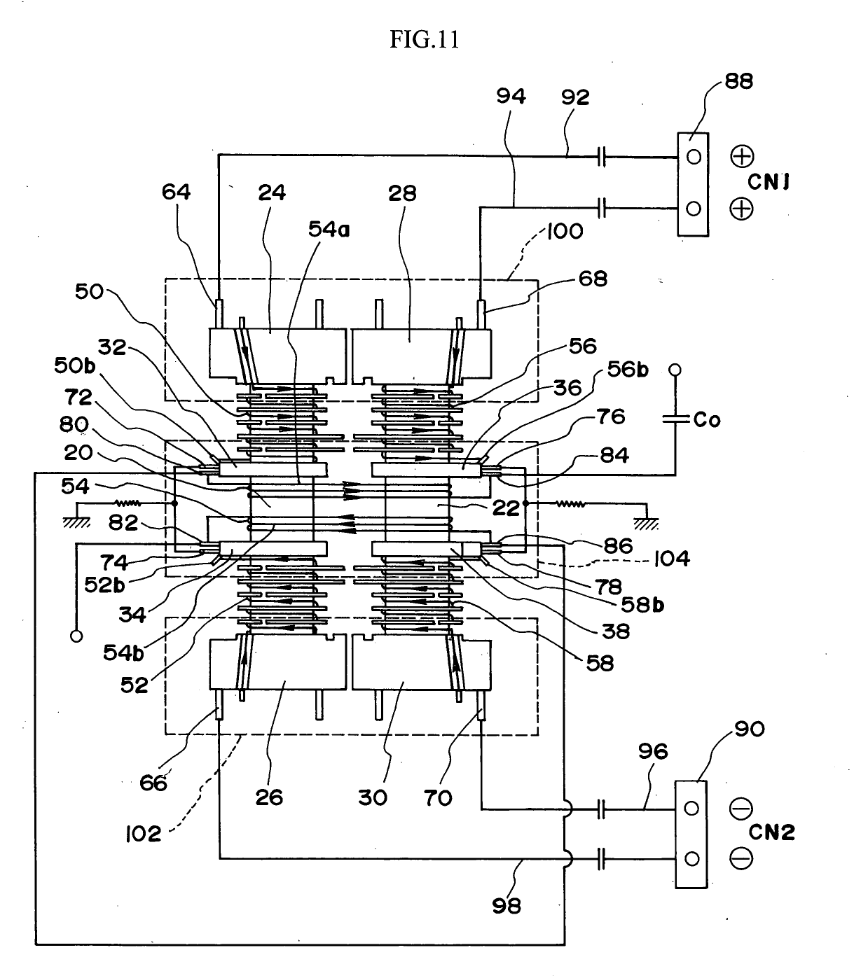

FIG. 11 shows another embodiment of the present invention, and the secondary side ground terminals 72, 74 are provided on each of the terminal mounting portions 32, 34 provided at both sides of the primary winding 54 mounted on the bobbin terminals 76, 78 are provided on each of the terminal mounting portions 36, 38 provided at both ends of the primary winding 54 wound on the bobbin 22 in its axial direction. The winding terminate ends 50b, 52b of the secondary windings 50, 52 are respectively connected to the corresponding secondary side terminals 72, 74, and the winding terminate ends 56b, 58b of the secondary windings 56, 58 are connected to the corresponding secondary side terminals 76, 78.

The secondary side ground terminals 72, 74 are connected in series by means of the lead wires, and the lead wires are earthed through the high resistance element. Also, the secondary ground terminals 76, 78 are connected in series by means of the lead wires, and the lead wires are earthed by means of the high-resistance element. The CN1, CN2 are connectors mounted on the printed circuit board (illustration is omitted), and the lamps (illustration is omitted) installed on the board is connected to the connector as shown in FIG. 10. The connector CN1 is connected to the secondary side terminals 64, 68 by means of the lead wires 92, 94, and the connector CN2 is connected to the secondary side terminals 66, 70 by means of the lead wires 98, 96. Other constructions are identical with the mode of the embodiment shown in FIG. 8, and the description is omitted.

In the foregoing construction, the transformer is divided to the high voltage terminal disposed regions 100, 102 opposed to the connectors CN1 and CN2 at the shortest distance, and to the low-voltage terminal disposed region 104 positioned at the rearward of the high-voltage terminal disposed regions 100, 102 relative to the connectors CN1, CN2. By this arrangement, there is no chance of the low-voltage secondary ground terminals 72, 74, 76, 78 into the high-voltage regions 100, 102, and the insulation distance between secondary side terminal 64 and the secondary ground terminal 72, and between the secondary side terminal 68 and the secondary ground terminal 76 and between the secondary side terminal 66 and the secondary ground terminal 74 and between the secondary side terminal 70 and the secondary ground terminal 78 become larger, and thus the discharge or the like between them can be prevented, and thus, the transformers can be operated safely.

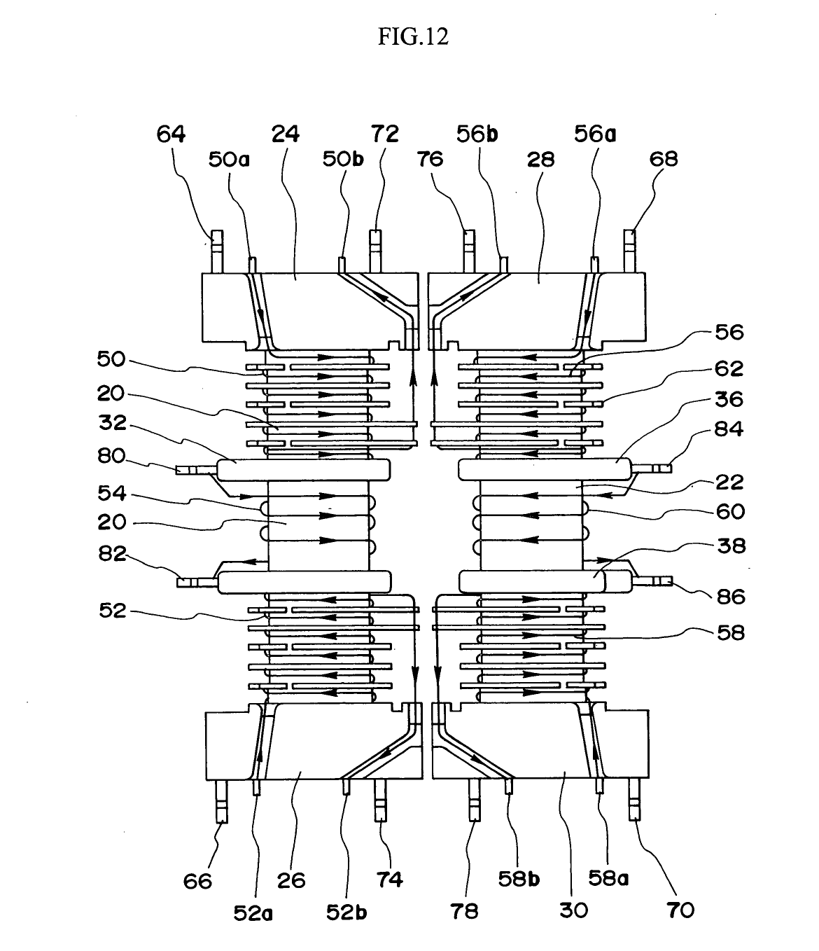

FIG. 12 shows the another embodiment of the present invention.

The secondary winding 50 is wound in the right-turn as shown by the arrow mark in the drawing on the basis of the winding start end 50a as the standard, and the secondary winding 56 opposed to the winding in parallel is wound in the left turn on the basis of the winding start end 56a as the standard, and the secondary windings 50, 56 are opposite in the winding directions mutually. Also, the secondary windings 52, 58 are similar, and the secondary winding 52 being the left-turn, and the secondary winding 58 being the right-turn, and the winding directions of both the windings are counter directions.

Furthermore, the primary windings 54, 60 are similar such that the primary winding 54 is of the right-turn with the winding start end as the standard, and the primary winding 60 is the left-turn and both the windings are mutually of counter-direction. As described above, when the winding directions of the windings which are opposed and in parallel are reversed, the oscillation by the magnetic force of the windings can be cancelled out, preventing the heat generation of the windings. The primary windings 54, 60 are connected in parallel or in series. The outputs of the secondary high-voltage terminals 64, 68 are mutually in identical phase, and the secondary high-voltage terminals 66, 70 become the counter phase to the secondary high-voltage terminals 64, 68. Namely, when the secondary terminals 64, 68 are the plus charge, the secondary terminals 66, 70 are the minus charge. The winding terminate ends 50b, 56b, 52b, 58b of the secondary terminals 50, 56, 52, 58 are respectively connected to the ground terminals 72, 76, 74, 78. Other constructions of the present embodiment are identical with the transformer shown in FIG. 1, and the identical codes are applied to the identical portions, and the description is omitted.

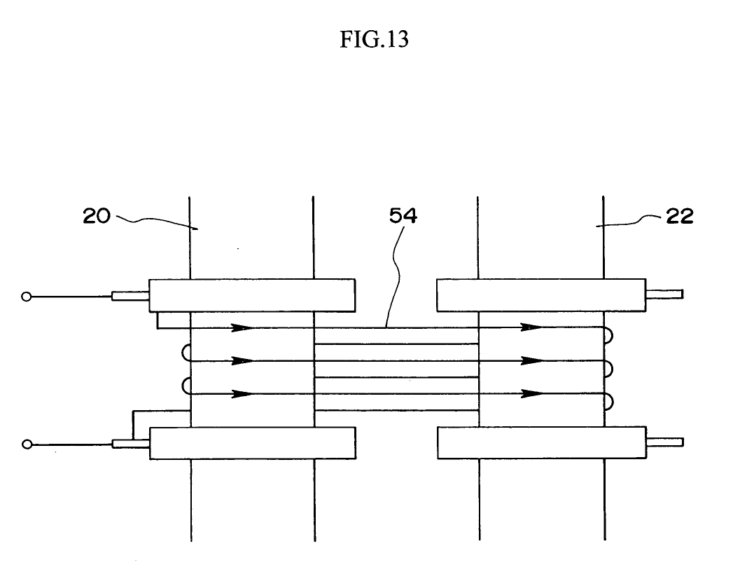

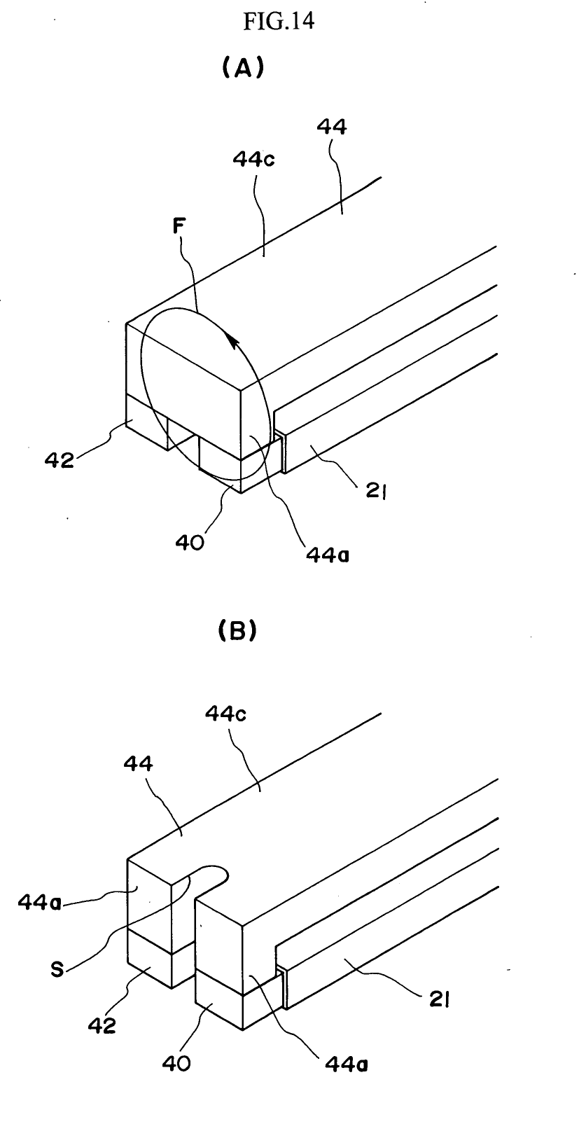

FIG. 13 shows the embodiment mode wherein the primary winding 54 is wound in the same direction on the bobbins 20, 22 across the bobbins 20, 22 of two pieces of the I type core. Namely, the primary winding 54, as shown in FIG. 11, is not particularly limited to the construction of the counter direction winding. FIG. 14 shows a countermeasure of the magnetic flux F in the arrow direction formed in the direction orthogonal with the longitudinal direction of the C-type cores shown in FIG. 14 (A). As this countermeasure, the embodiment mode shown in FIG. 14(B) provides the notch (S) at both ends of the flat plate portion 44c of the C-type core 44c in order to eliminate the magnetic flux F.

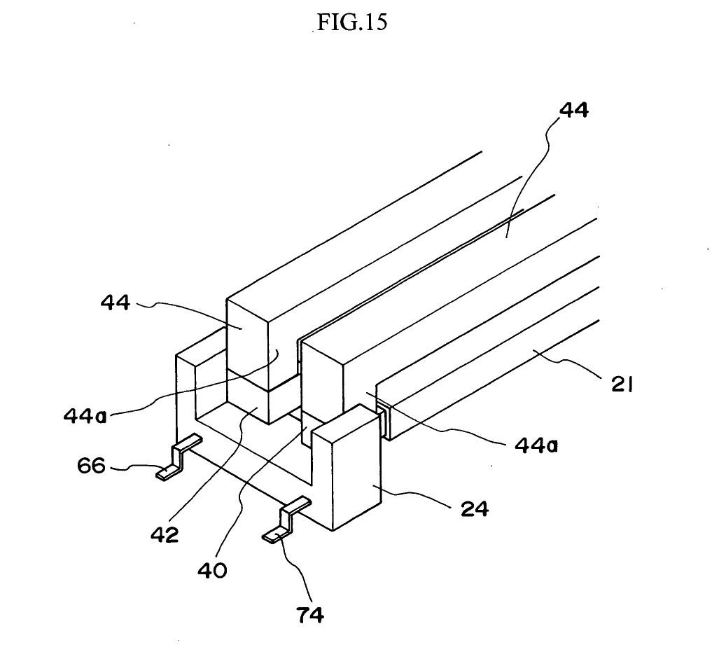

In the foregoing embodiments without exception, the single C-type core is coupled to a plurality of the I type cores but, as shown in FIG. 15, the respectively independent one piece C-type core 44 may be coupled to a plurality of the I type cores 40, 42.

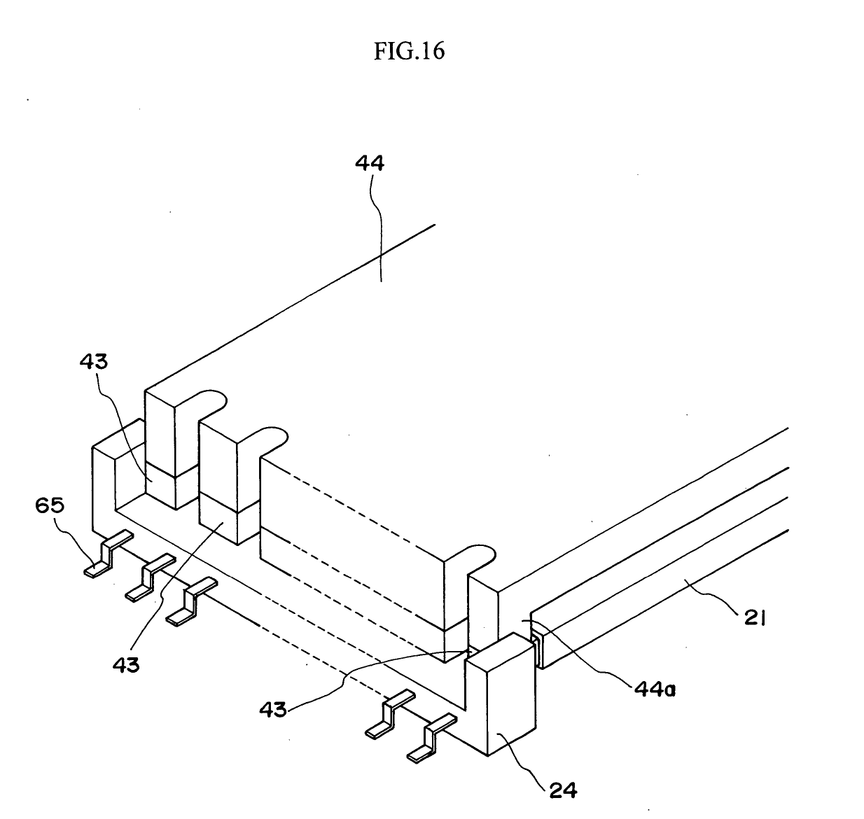

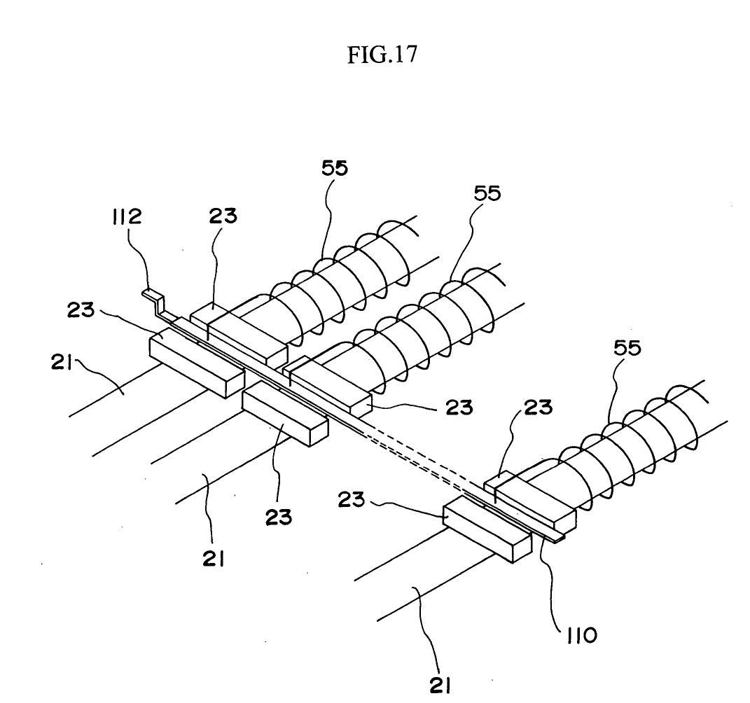

FIG. 16 shows the embodiment mode wherein the C type core 44 is coupled with more than 3 pieces of the I type cores 43. The secondary side terminal 65 is mounted on the terminal mounting portion 24 of the bobbin 21 in which each I type core 43 is housed, and the winding start end of the secondary winding mounted on the bobbin 21 is connected to the terminal 65. As shown in FIG. 17, the lead wire of the primary winding 55 is led to the partition 23 for insulation, as shown in FIG. 17, and each lead wire is connected to an elongated metal electrode 110 mounted on the bobbin 21, The metal electrode 110 is connected to the primary winding 112 mounted on the partition 23. The winding terminal end of each secondary winding, namely, the side closer to the primary winding of each of the secondary windings is connected to the metal electrode (illustration is omitted) for secondary terminal by means of the lead wire in the same construction. The metal electrode for the secondary terminal is mounted on the bobbin in the adjacency of the partition 23.

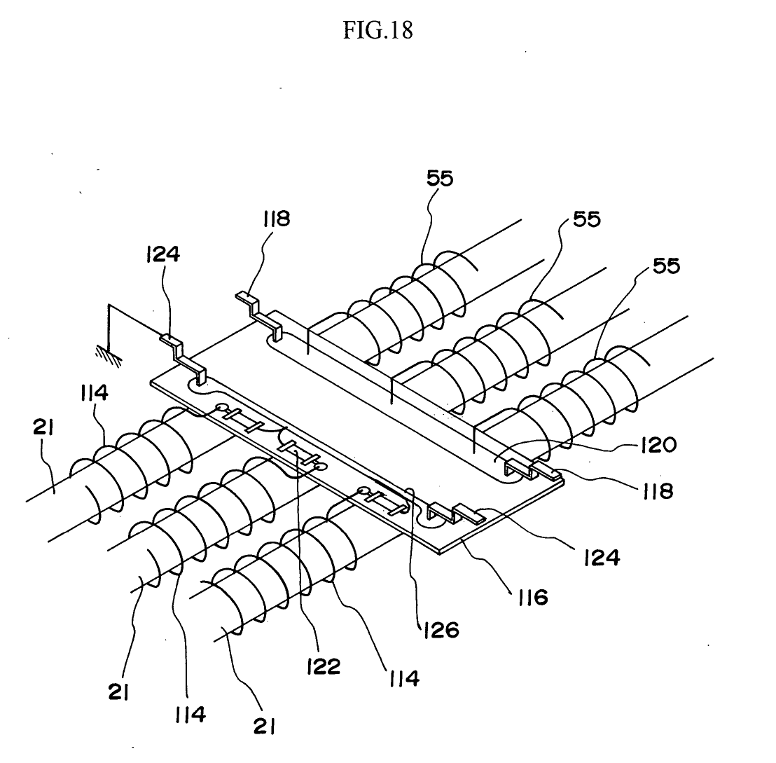

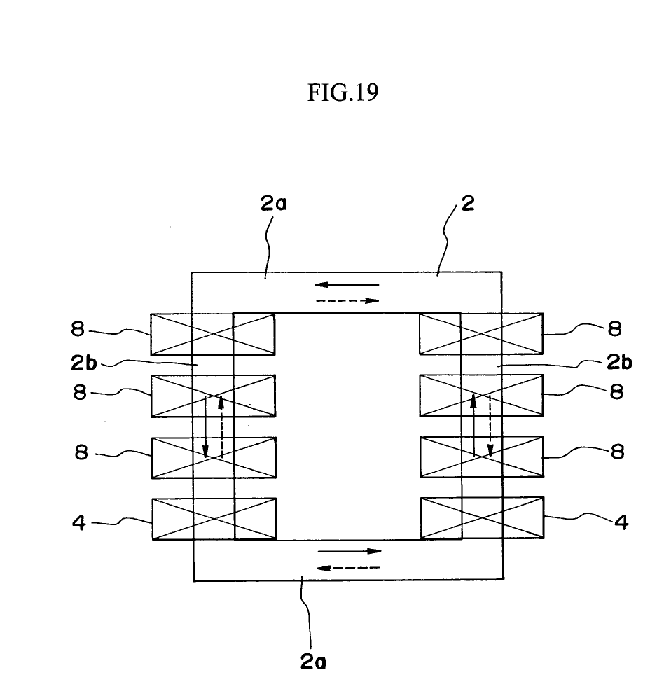

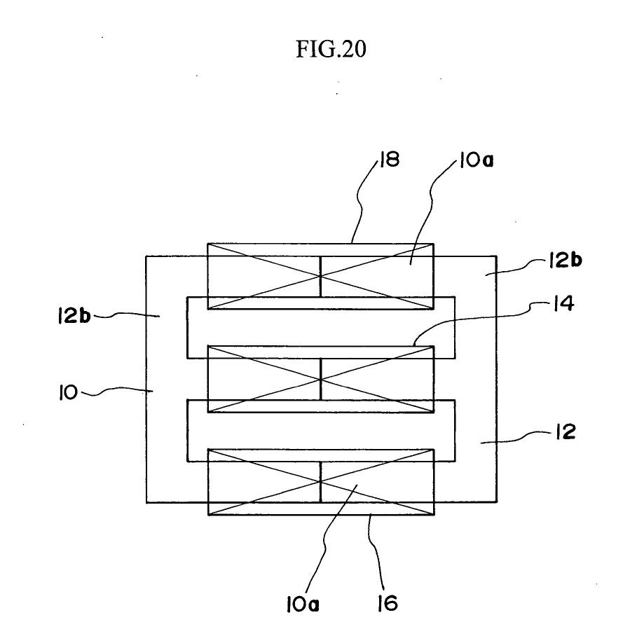

FIG. 18 is a skeleton explanatory view using more than 3 pieces of the I type cores, and the bottom view of the transformer is shown. In the border of the primary winding 55 and the secondary winding 114 mounted on the bobbin 21 into which each of the I type cores is housed, the wired board such as the printed circuit board 116 and the like is disposed and fixed. The lead wire of the end portion of each of the primary windings 55 is connected to the elongated metal electrode 120. The primary terminal 118 is connected to both terminals of the elongated metal electrode 120. The elongated metal electrode 126 connected to the ground terminals 124, 124 is connected to the lead wire of the winding terminate end of the secondary winding 114 by means of the electronic device 122 such as chip resistors and the like.

What is claimed is:

1. A transformer wherein more than two pieces of I type cores disposed in parallel at a predetermined interval and C-type cores disposed by being piled up in perpendicular direction at a predetermined interval on the plane I type c ores that are disposed in parallel are provided, and wherein the primary windings are mounted on the respective I type cores by means of the bobbins, and the secondary windings are mounted by means of the bobbins in the vicinity of both the sides of the primary windings, and the secondary sides are made at least the 4 winding outputs.

2. A transformer according to the claim 1, wherein the C type cores are disposed at both the surfaces of the I type cores.

3. A transformer according to the claim 1, wherein the C type cores are disposed at each of the I type cores, and each of the C type cores is mutually separated.

4. A transformer according to the claim 1, wherein each of the secondary windings is made of a plurality of electric wires disposed in parallel, and the secondary side is made at least 8 winding outputs.

5. A transformer according to the claim 1, wherein end portions of each of the secondary windings at the side closer to the primary windings are connected to the ground terminals provided on the bobbins.

6. A transformer according to the claim 1, wherein the winding direction of the secondary windings that are opposed in the parallel direction are made mutually in counter directions, and the winding direction of the primary windings that are opposed in the parallel direction are made mutually in counter directions.

7. A transformer according to the claim 1, wherein a notch that blocks the formation of the line of the magnetic force in the direction orthogonal with a longitudinal direction of the C type cores is formed at the end portion of the C type core.

8. A transformer according to the claim 1, wherein an elongated metal electrode is mounted at each side of the primary winding mounted on each of the bobbins, and both ends of the primary winding are connected to the metal electrode, and an elongated metal electrode for secondary winding is mounted on each of the bobbins in adjacency of the metal electrode for the primary windings, and the end portion of the secondary winding is connected to the metal electrode which is at the side closer to the primary winding.

9. A transformer according to the claim 1, wherein a wired board is disposed at both sides of the primary winding mounted on each of the bobbins, and an elongated electrode for primary winding and an elongated electrode for secondary winding are provided on the wired board, and both the ends of each of the primary windings is connected to the metal electrode for the primary winding, and the end portion of each of the secondary windings which is the side closer to the primary winding is connected to the metal electrode for the secondary winding by means of the resistance element.

10. A transformer according to the claim 1, wherein the winding direction of the secondary winding and the primary winding adjacent to the winding are identical.

11. A transformer wherein I type cores are respectively inserted into at least two pieces of the bobbins that are connected in parallel, and a primary winding is mounted in the middle of the respective bobbins, and the secondary winding is mounted at each side of the primary winding, and C type cores are superposed on the parallel plane of the I type cores in a perpendicular direction relative to the parallel plane at a predetermined distance, and the convex portions at both ends of the C type cores are connected to both ends of the I type cores, and a terminal mounting portion is provided on the high-voltage terminal disposed region of the bobbin, and the first terminal adjacent to the one end of the secondary winding is mounted on the first terminal mounting portion of the high-voltage terminal disposed portion, and the second terminal adjacent to the other end of the secondary winding mounted on the bobbin is mounted on the second terminal mounting portion of the low-voltage terminal disposed region of the rear at a predetermined distance relative to the high-voltage terminal disposed region, and the second terminal is made as the ground terminal.

12. A transformer according to the claim 11, wherein the high-voltage terminal disposed region is provided in the vicinity of both the end portions of the I type cores, and the low-voltage terminals disposed region is provided in the vicinity of the central portion of the I type cores, and a primary terminal connected to the first primary winding is disposed in the low-voltage terminal disposed region, and the ground terminal is disposed in the vicinity of the primary terminal.

13. A transformer according to the claim 11, wherein the first terminal mounting portion is provided at each end side of the longitudinal direction of each of the bobbins, and the second terminal mounting portion is provided at both end sides of the primary winding in the axial direction.

14. A transformer comprising I type cores respectively inserted and arranged in at least two pieces of bobbins connected in parallel, C type cores disposed by being piled up on the parallel plane of the I type cores in a perpendicular direction relative to the parallel plane at a predetermined interval whose convex portions at both ends being connected to both end portions of each of the I type cores, primary windings mounted in the middle of each of the I type cores by means of the bobbins, secondary windings at one side which are mounted on each of the I type cores by means of the bobbins, secondary windings at the other side which are mounted on the other sides of the primary windings by means of the bobbins, terminal mounting portions at one side provided at one end side of each of the bobbins and having the one side high-voltage secondary terminals which are connected to the winding start ends of the one side secondary windings, and the other side secondary terminal mounting portions provided at the other end side of each of the bobbins and having the other side secondary terminals connected to the winding start ends of the other side secondary windings, wherein the primary and secondary ground terminals are provided on the one side terminal mounting portions, and the terminate ends of the one secondary windings among the one side secondary windings are connected to the first secondary ground terminals, and the other winding terminate ends of the other secondary windings among the one side secondary windings are connected to the second secondary ground terminals, and the third and fourth secondary ground terminals are provided on the other side terminal mounting portions, and the winding terminate ends of the one secondary windings among the other side secondary windings are connected to the third secondary ground terminals, and the winding terminate ends of the other secondary windings among the other side secondary windings are connected to the fourth secondary ground terminals.

15. A transformer according to the claim 14, wherein the winding directions of the one side secondary windings are mutually made identical, and the winding direction of the other side secondary windings is made a counter direction relative to the winding direction of the one side secondary windings, and the winding direction of the portion of the primary windings adjacent to the one side secondary windings is made identical with the winding direction of the one side secondary windings, and and the winding direction of the portion of the primary windings adjacent to the other side secondary windings is made identical with the winding direction of the other side secondary windings.

16. A transformer according to the claim 14, wherein the fifth and sixth terminal mounting portions are respectively provided at the rear of the one side secondary windings. and the first and second secondary ground terminals are provided on the fifth and sixth terminal mounting portions, and the winding terminate end of the secondary windings among the one side secondary windings are connected to the first secondary ground terminals, and the winding terminate ends of the other secondary windings among the one side secondary windings are connected to the second secondary ground terminals, and the seventh and eighth terminal mounting portions are provided at the rear of the other side secondary windings, and the third and fourth secondary ground terminals are provided on the seventh and eigth side terminal mounting portions, and the third and fourth secondary ground terminals are provided on the seventh and eigth side terminal mounting portions, and the winding terminate ends of the secondary windings of the one side among the other side secondary windings are connected to the third secondary ground terminals, and the winding terminate ends of the other secondary windings among the other side secondary windings are connected to the fourth secondary ground terminals.

17. A transformer according to the claim 15, wherein the winding start ends of the one part and the winding start ends of the other part of the one part among portions of two pieces of the primary windings whose winding directions are mutually different are connected in series, and the winding terminate ends of the one part and the winding terminate ends of the other part are made ass the primary input portions.

18. A transformer according to the claim 14, wherein the first secondary ground terminals and the third secondary ground terminal are connected in series, and the second secondary ground terminals and the fourth secondary ground terminals are connected in series.

19. A transformer according to the claim 14, wherein the high-voltage secondary terminals of the one side terminal mounting portions is connected to one connector having a pair of terminals for lamp connection. and the high-voltage secondary terminals of the other side terminal mounting portions are connected to another connector having a pair of terminals for lamp connection.
